(19) United States
(12) Patent Application Publication
(10) Pub. No.: US 2025/0016048 A1
(43) Pub. Date: Jan. 9, 2025

(54) METHOD AND SYSTEM FOR MODIFYING STATE OF DEVICE USING DETECTED ANOMALOUS BEHAVIOR

(71) Applicant: Elisa Oyj, Helsinki (FI)

(72) Inventor: Mateo RENDON, Helsinki (FI)

(73) Assignee: Elisa Oyj, Helsinki (FI)

(21) Appl. No.: 18/710,031

(22) PCT Filed: Dec. 8, 2022
(86) PCT No.: PCT/FI2022/050814

§ 371 Date: May 14, 2024

(30) Foreign Application Priority Data
Dec. 17, 2021 (FI) 20216298

(51) Int. Cl. H04L 41/0816; H04L 9/40; H04L 41/0604; H04L 43/16

(52) U.S. Cl. CPC H04L 41/0816; H04L 41/0604; H04L 43/16; H04L 63/1425

(57) ABSTRACT

A method and system for modifying a state of a device using detected anomalous behaviour in a self-exciting point process includes receiving time series data for a time period of the self-exciting point process, selecting a first portion, corresponding to a first time period, from the received time-series data, characterizing a normal behaviour for the first time period of the self-exciting point process, defining a baseline range for the self-exciting point process based, at least in part, on bounds of first point values in the selected first portion, processing a second portion based on the defined baseline range to detect one or more second point values exceeding the defined baseline range being characterized as the one or more anomalous events for at least the second time period of the self-exciting point process and modifying the state of the device based on the characterized one or more anomalous events.

### TECHNICAL FIELD

The present disclosure relates generally to automated anomaly detection systems and methods and more specifically, to a system, a method and a computer program for modifying a state of a device using detected anomalous behavior in a self-exciting point process.

### BACKGROUND

In recent years, increasing growth in technology has led to rapid development of various fields, such as telecommunication, networking industry, entertainment, epidemiology, geography, seismology, material science, astronomy, computational neuroscience, economics, and the like. Such industries are growing exponentially, and their products and services are being utilized by millions of users worldwide, such as by customers and/or subscribers employing such products or services. Thus, to provide such products and services to the users, a vast network of various components, devices and connections is developed. However, the vast network is prone to errors and inefficiencies during operation such as due to the presence of anomalies and are thus required to be detected.

Moreover, knowledge of the likelihood of an event (such as, an anomaly) occurring at a given time is a problem of interest for many fields. For example, in seismology, the occurrence of earthquakes; in epidemiology, the occurrence of contagion of a virus; in public policy, the occurrence of criminal activity in a city and the like. Such real world event occurrences can be modelled via point processes as points in time, and from the distribution of points, the rate of occurrence or the likelihood of a future event occurrence based on a given is possible. Moreover, self-exciting point processes are a special case of point processes where previous points (or events) increase the rate of occurrence of future events (or anomalies).

In conventional systems, the process of anomaly detection is done manually by domain experts based on the level of expertise and knowledge in respective domains and thereby addressed as per requirement (such as, by service personnel or domain experts), thereby making the systems time-consuming and complex. In an exemplary scenario of telecommunication domain, such as, during monitoring of local access network (LAN) key performance indictors (KPI's), the relevance of different t types of anomalies is dictated by telecommunication engineers, based on their level of knowledge and experience monitoring faults in the mobile network. However, such a method is tedious, time consuming and prone to significant inaccuracies, specially while maintaining vast processes, systems or networks.

Therefore, in light of the foregoing discussion, there exists a need to overcome the aforementioned drawbacks associated with the conventional systems and provide an improved system and method for modifying a state of a device using detected anomalous behavior in a self-exciting point process.

### SUMMARY OF THE INVENTION

The present disclosure seeks to provide a method for modifying a state of a device using detected anomalous behavior in a self-exciting point process. The present disclosure also seeks to provide a system for modifying a state of a device using detected anomalous behavior in a self-exciting point process. An aim of the present disclosure is to provide a solution that overcomes at least partially the problems encountered in prior art.

In one aspect, an embodiment of the present disclosure provides a method for modifying a state of a device using detected anomalous behaviour in a self-exciting point process, comprising:
receiving time series data for a time period comprising point values for respective time instants of the time period for the self-exciting point process, wherein the time series data is a series of the point values with respect to time, wherein the point values are data points in the time series data, and wherein the self-exciting point process is obtained as the series of the point values that indicates one or more anomalous events where the point values of the time series data fall outside a baseline range;
selecting a first portion, corresponding to a first time period, from the received time-series data, characterizing a normal behaviour for at least the first time period of the self-exciting point process;
determining an intensity of a given anomalous event of the one or more anomalous events based on at least one of a number and a proximity in time of preceding anomalous events of the one or more anomalous events to the given anomalous event;
determining, for the second time period, presence of at least one anomalous event of the one or more anomalous events with the corresponding determined intensity exceeding a predefined intensity threshold;
determining, for a third time period, presence of at least one anomalous event with a corresponding determined intensity exceeding the predefined intensity threshold, with the third time period succeeding the second time period;
confirming the anomalous behaviour for the self-exciting point process based on the determined presence of at least one anomalous event with the corresponding determined intensity exceeding the predefined intensity threshold for each of the second time period and the third time period; and
modifying the state of the device based on the confirmation of the anomalous behaviour for the self-exciting point process, wherein the modified state is at least one of an active state or an inactive state.

In another aspect, an embodiment of the present disclosure provides a system comprising a processor, and a memory including computer program code; the memory and the computer program code configured to, with the processor, cause the apparatus to perform the method of the abovementioned claims.

In yet another aspect, an embodiment of the present disclosure provides a computer program comprising computer executable program code which when executed by a processor causes a system to perform the method of any one of the abovementioned claims.

In yet another aspect, an embodiment of the present disclosure provides a system for modifying a state of a network device, implemented in a networked environment, using detected anomalous behaviour in a self-exciting point process, the system comprising a processor and a memory comprising computer program code, configured to:
receive time series data, associated with the network device, for a time period comprising point values for respective time instants of the time period for the self-exciting point process, wherein the time series data is a series of the point values with respect to time, wherein the point values are data points in the time series data, and wherein the self-exciting point process is obtained as the series of the point values that indicates one or more anomalous events where the point values of the time series data fall outside a baseline range;
select a first portion, corresponding to a first time period, from the received time-series data, characterizing a normal behaviour for at least the first time period of the self-exciting point process;
define a baseline range for the self-exciting point process based, at least in part, on bounds of first point values in the selected first portion;
process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process;
determine an intensity of a given anomalous event of the one or more anomalous events based on at least one of a number and a proximity in time of preceding anomalous events of the one or more anomalous events to the given anomalous event;
determine, for the second time period, presence of at least one anomalous event of the one or more anomalous events with the corresponding determined intensity exceeding a predefined intensity threshold;
determine, for a third time period, presence of at least one anomalous event with a corresponding determined intensity exceeding the predefined intensity threshold, with the third time period succeeding the second time period;
confirm the anomalous behaviour for the self-exciting point process based on the determined presence of at least one anomalous event with the corresponding determined intensity exceeding the predefined intensity threshold for each of the second time period and the third time period; and
modify the state of the network device based on the confirmation of the anomalous behaviour, wherein the modified state is at least one of an active state or an inactive state.

Embodiments of the present disclosure substantially eliminate or at least partially address the aforementioned problems in the prior art and enable automation of the anomaly detection and thereby the modification of the device using detected anomalous behaviour.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a flowchart listing steps involved in a method for modifying a state of a device using detected anomalous behaviour in a self-exciting point process, in accordance with an embodiment of the present disclosure;

FIG. 2 is a schematic illustration of a block diagram of a system for modifying a state of a device using detected anomalous behaviour in a self-exciting point process, in accordance with an embodiment of the present disclosure;

FIG. 3 is an exemplary schematic illustration of a network environment comprising a system for modifying a state of a network device using detected anomalous behaviour in a self-exciting point process, in accordance with an embodiment of the present disclosure;

FIGS. 4A and 4B are graphical illustrations of a first time series data and second time series data depicting normal behaviour, in accordance with various embodiments of the present disclosure;

FIGS. 5A and 5B are graphical illustrations of a first time series data and second time series data depicting anomalous behaviour in self-exciting point processes, in accordance with various other embodiments of the present disclosure;

FIG. 6 is a graphical illustration of a time series data depicting anomalous behaviour in a self-exciting point process, in accordance with another embodiment of the present disclosure; and

FIG. 7 is a graphical illustration of a time series data depicting anomalous behaviour in a self-exciting point process, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for modifying a state of a device using detected anomalous behaviour in a self-exciting point process, comprising:
receiving time series data for a time period comprising point values for respective time instants of the time period for the self-exciting point process;
selecting a first portion, corresponding to a first time period, from the received time-series data, characterizing a normal behaviour for at least the first time period of the self-exciting point process;
defining a baseline range for the self-exciting point process based, at least in part, on bounds of first point values in the selected first portion;
processing a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process; and
modifying the state of the device based on the characterized one or more anomalous events.

In another aspect, an embodiment of the present disclosure provides a system comprising a processor, and a memory including computer program code; the memory and the computer program code configured to, with the processor, cause the apparatus to perform the method of the abovementioned claims.

In yet another aspect, an embodiment of the present disclosure provides a computer program comprising computer executable program code which when executed by a processor causes a system to perform the method of any one of the abovementioned claims.

In yet another aspect, an embodiment of the present disclosure provides a system for modifying a state of a network device, implemented in a networked environment, using detected anomalous behaviour in a self-exciting point process, the system comprising a processor and a memory comprising computer program code, configured to:
receive time series data, associated with the network device, for a time period comprising point values for respective time instants of the time period for the self-exciting point process;
select a first portion, corresponding to a first time period, from the received time-series data, characterizing a normal behaviour for at least the first time period of the self-exciting point process;
define a baseline range for the self-exciting point process based, at least in part, on bounds of first point values in the selected first portion;
process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process; and
modify the state of the network device based on the characterized one or more anomalous events, wherein the modified state is at least one of an active state or an inactive state.

The present disclosure provides a method for modifying a state of a device using detected anomalous behaviour in a self-exciting point process. The term “anomaly” or “anomalous behaviour” refers to a behaviour deviating from a normal or expected behaviour, suggesting a different underlying mechanism that leads to the generation of the anomaly. The method is configured to identify data points, events, and/or observations that deviate from normal behaviour i.e., exhibit anomalous behaviour, wherein the anomalous behaviour indicates critical incidents, such as technical issues or glitches, or changes in behaviour or operation of the device. The detected anomalous behaviour relates to anomalies present in any self-exciting point process, for example associated with an operation of a component or the device, wherein any issues or errors during operation of said component or device is deemed an anomaly. In conventional systems, the anomaly detection is done manually by domain experts based on the level of expertise and knowledge in respective domains and thereby addressed as per requirement (such as, by service personnel or domain experts), thereby making the systems time-consuming and complex. In an exemplary scenario of telecommunication domain, such as, during monitoring of radio access network (RAN) key performance indictors (KPI's) or Long-term Evolution (LTE) KPI's, the relevance of different types of anomalies is dictated by telecommunication engineers, based on their level of knowledge and experience monitoring faults in the mobile network. However, such a method is tedious, time consuming and prone to significant inaccuracies, specially while maintaining vast processes, systems or networks. Thus, to overcome the aforementioned problems, the method of the present disclosure enables detection of anomalous behaviour based on a plurality of parameters by use of the trained one or more machine learning models, and thereby modifying the state of the device using the detected behaviour in the self-exciting point process and beneficially providing a time-effective and efficient operation as compared to the conventional systems. Typically, the method is configured for detecting anomalous behaviour in a time series (for e.g., telecommunication key performance indicators (KPI)) by formulating or interpreting the time series values outside a defined normal range as a point process. Consequently, a self-exciting behaviour of the point process (also referred to as the self-exciting point process or the anomaly point process) is equivalent to an anomalous behaviour in the time series. The self-exciting point process is obtained as the set of points (or time instants) with respect to time, wherein the time series values falling outside a defined normal range (as later described in the disclosure). The “state” refers to a current operational or physical state of the device or component being monitored and analyzed by the method. In an example, the state of a device may relate to a power status, position, operability, reliability, accessibility, mobility and the like. Beneficially, the method employs the characterized one or more anomalous events in the self-exciting process and based on which modifies the state of the device. It will be appreciated that the method for modifying the state of the device using detected anomalous behaviour in the self-exciting point process may be implemented in a variety of manners based on the implemented domain including, but not limited to, telecommunication, networking, electronics, analytics, security, seismology and the like and according based on the implementation the modification of the state of the device may vary without limiting the scope of the present disclosure.

In an embodiment, the device is at least one of: a network device, a communication device, a telecommunication device, a computing device. The device refers to any type of component, tool or equipment being monitored and analyzed via the method to detect anomalous behaviour therein. The device is at least one of the network device such as, hubs, repeaters, bridges, gateways, access points; the switches, telecommunication device such as, telecom towers, fiber-optic connections, routers, internet protocols (IP) of voice over (VOIP), pagers, wireless devices, modems, local area networks (LANs), teleprinters, satellites, transceivers, or the computing device such as, laptops, tablets, smartphones, smart watches, smart glasses, controllers, and so forth. It will be appreciated that the method of the present disclosure is not limited to the aforementioned devices (or equipment's) and applicable to a spectrum of other types of devices whose anomalous behaviour is required to be detected without limiting the scope of the present disclosure. Optionally, the time series data is a measured key performance indicator (KPI) value relating to the device. The measured KPI is associated with the device and indicates a performance of the device being monitored. For example, the KPI is a telecommunication KPI such as, a radio access network (RAN) KPI or Long-term Evolution (LTE) KPI. Beneficially, the measured KPI enables the method to compare and contrast at least one of technology, service availability, performance, network metrics, errors or failures, congestion, deployment issues and so forth associated with the monitored device.

The method comprises receiving time series data for a time period comprising point values for respective time instants of the time period for the self-exciting point process. The term “time series data” refers to a dataset or a series of data points (or point values) indexed (or listed or graphed) in a temporal order. The time series data is a sequence taken at successively spaced time instants of the time period and comprises a sequence of discrete-point values for respective time instants of the time period for the self-exciting process. Optionally, the time instants are spaced at equal intervals. Optionally, the time instants are spaced at varying intervals. Generally, the time series data includes large volumes of data having a high dimensionality, wherein the data in the time series is added and analyzed dynamically as time progresses. Moreover, the time series may be updated in real time, specifically at the successively spaced points values or time instants. Herein, the time series data is associated with a time period comprising a plurality of time periods comprising point values for respective time instants for the self-exciting process. Typically, the received time series data may be associated with an operation or performance of the device and thereby analyzing and/or processing the received time series data via the method enables detection of anomalies associated with the device and beneficially allows for further modification thereafter.

The method further comprises selecting a first portion, corresponding to a first time period, from the received time-series data, characterizing a normal behaviour for at least the first time period of the self-exciting point process. Typically, upon receiving the time series data, the method comprises selecting the first portion corresponding to the first time period from amongst the plurality of time periods associated with the time series data, whereby the selected first portion is used to characterize the normal behaviour for at least the first time period. The time series data comprises plurality of portions associated with corresponding plurality of time periods. For example, a first portion associated with a first time period, a second portion associated with a second time period and so forth. Typically, to enable detection of anomalies, the method comprises characterizing the normal behaviour of each time series (or portion thereof) in the time series data. The normal time series behaviour is characterized by a relatively stationary curve, i.e., trend and volatility are almost constant, wherein the stationary trend is modelled using the method via plurality of modelling means to define a prediction interval. The first time period may be referred to as a warm-up period that is reserved for learning accurate approximations of the trend and prediction interval of the self-exciting point process. Typically, after the first period or the warm-up period, any time series characterizing normal behaviour will possess a substantially stationary curve defined within a normal range defined by the prediction interval based on the selected first portion.

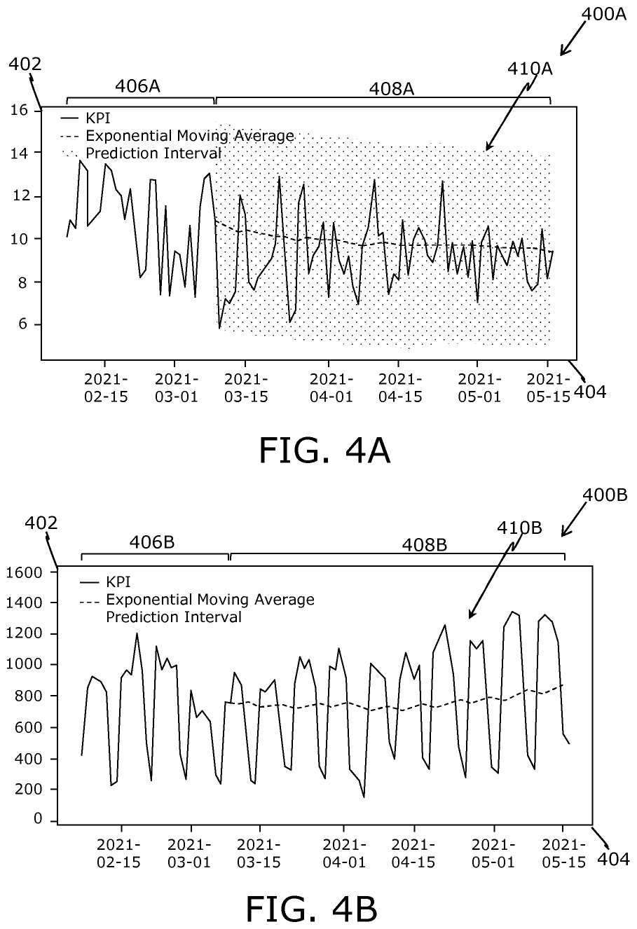

The method further comprises defining a baseline range for the self-exciting point process based, at least in part, on bounds of first point values in the selected first portion. The “baseline range” refers to a prediction interval or range for the self-exciting point process, wherein the baseline range is based at least in part on the bounds of the first point values in the selected first portion. The bounds of the first point values refer to the maximum positive or negative deviation of the point values of the selection first portion based on which the baseline range is defined. In an exemplary scenario, the bounds of the baseline range may be defined by 125% of the first bound values of the selected first portion, such as in case the bounds of first point values of the selection first portion comprises an upper bound value of +30 units and a lower bound value of −20 units, then the baseline range may be defined in the range of +37.5 units and −25 units. Beneficially, the baseline range defines the normal behaviour for the entire self-exciting point process, wherein a performance of any portion of the time series may be compared against the baseline range to detect anomalies present (if any) in the respective time period. Details of exemplary selected first portions and defined baseline ranges for respective time series are illustrated in FIGS. 4A and 4B.

In an embodiment, defining the baseline range comprises computing an exponential moving average estimation for the selected first portion of the received time series data. The “exponential moving average” (EMA) estimation, also known as an exponentially weighted moving average (EWMA) estimation refers to a first-order infinite impulse response filter configured to apply weighting factors decreasing exponentially (and increase gradually or linearly). Typically, to define the baseline range, the method further comprises computing the exponential moving average estimation for the selected first portion. Notably, the baseline range characterizes a stationary trend or normal behaviour of the self-exciting point process associated with the time series data and may be modelled by a moving average estimation, e.g., cumulative moving average, weighted moving average or exponential moving average estimation. Herein, the baseline range is defined via the exponential moving average estimation for the selected first portion of the received time series data, wherein the exponential estimation comprises a low discounting rate. Moreover, the baseline range also characterizes constant volatility and may be computed as the standard deviation of the residual multiplied by a coefficient accounting for uncertainty (e.g., a 95% interval or baseline range based on previous history). In another embodiment, the exponential moving average estimation is based on the bounds of first point values and a weighting factor. The selected first portion comprises the first point values defined between an upper bound and a lower bound i.e., bounds of the first point values. Typically, the exponential moving average estimation for a time series (Y) may be computed recursively as (Sₜ=Y₁; at time t=0) and (Sₜ=αYₜ+(1−α)Sₜ₋₁ at t>0), wherein α is the weighting factor that refers to a constant smoothing factor ranging between 0 and 1. Notably, the method of the present disclosure employs the a comprising a low discounting rate. (i.e., a lower a discounts older observations at a slower rate and vice versa). Herein, (Yₜ) refers to point values at a time period (t), wherein the point values may be the bounds of the first point values for computing the exponential moving average estimation represented and (Sₜ) indicating value of the computed exponential moving average estimated at any time period (t). Optionally, defining the baseline range comprises computing via forecasting methods such as, simple moving average (SMA), exponential smoothing (SES) autoregressive integration moving average (ARIMA), neural network (NN), simple linear regression, multiple linear regression, and the like, for the selected first portion of the received time series data.

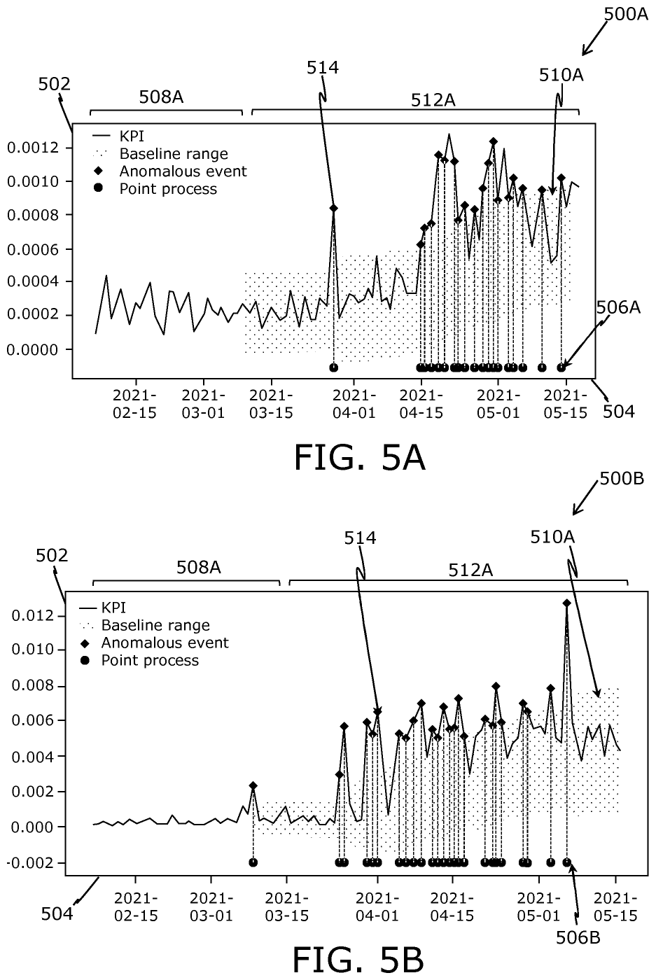

The method further comprises processing a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process. Generally, time series exhibiting normal behaviour remain within the bounds of the baseline range and wherein time series exhibiting anomalous behaviour inevitably fall outside the baseline range. For example, a level shift abruptly moves a time series beyond the baseline range, whereas a gradual upward or downward drift will cause succeeding point values (i.e., the second point values) to eventually fall beyond the baseline range. Upon defining the baseline range, the second portion corresponding to the second time period from the received time series data is selected to be processed. The second portion comprising the second point values at respective time instants of the second time period is processed or compared against the defined baseline range, wherein based on the processing the second point values exceeding the defined baseline range are characterized as the one or more anomalous events for at least the second time period. In an exemplary scenario, if the defined baseline range is the range of +25 units and −25 units, all second point values above the defined upper bound of +25 units or below the defined lower bound of −25 units are characterized as the one or more anomalous events. The one or more anomalous events refer to anomalies depicting anomalous behaviour of the time series data at respective time instants in the second time period. Notably, any time series with anomalous trend changes, the corresponding point process indicates a self-exciting behaviour since previous events increase the rate of occurrence of future events. Further, optionally, upon characterizing the one or more anomalous events, the method further comprises obtaining an anomaly point process, each of the one or more anomalous events corresponding to a point of the anomaly point process, wherein the anomaly point process is a self-exciting point process and indicates events where point values of the time series data fall outside the baseline range. The obtained anomaly point process or the self-exciting point process may further enable the method to determine intensity at each point (or time-instant) in the anomaly point process. Details of the characterized one or more anomalous events and the described anomaly point process for respective time series are illustrated in FIGS. 5A and 5B.

In an embodiment, the method further comprises determining an intensity of a given anomalous event of the one or more anomalous events based on at least one of a number and a proximity in time of preceding anomalous events of the one or more anomalous events to the given anomalous event. Upon characterizing the one or more anomalous events, the method further comprises determining the intensity of a given anomalous event of the one or more anomalous events. The “intensity” of a point process describes a rate of occurrence of an event (for example, the one or more anomalous events) at a given time instant, wherein the intensity value at a given time instant depends on the number and proximity in time of previous anomalous events. Notably, the value of the intensity increases by a constant upon each anomaly event occurrence and decreases exponentially in absence of such occurrences. Herein, the determined intensity enables the method to measure a severity of the duration of an anomalous event change and is configured to decay when the one or more anomaly events subside based on a weighting factor gamma (γ) for the intensity function describing the speed of decay. Beneficially, the intensity of each anomalous event provides another means for the method to detect or characterize the one or more anomalous events and thereby increases the accuracy of the method and further enables the corresponding modification action to be performed effectively.

In another embodiment, the method further comprises comparing the determined intensity of each of the one or more anomalous events with a predefined intensity threshold. To ascertain whether the characterized one or more anomalous events are actual anomalies i.e., affected by an underlying mechanism attributing to the anomalous behaviour the method is configured to confirm the anomalous behaviour for each of the characterized one or more anomalous events. Typically, upon determining the intensity of each of the one or more anomalous events, the method further comprises comparing the determined intensity of each of the one or more anomalous events with a predefined intensity threshold. The “predefined intensity threshold” refers to a pre-set maximum allowable intensity value characterizing normal behaviour and defined by the method (or domain experts) for either each individual anomalous event separately or of the one or more anomalous events collectively. Herein, upon comparing the intensity of each of the one or more anomalous events against the predefined threshold, the number of the one or more anomalous events exceeding the predefined threshold are counted and thereby compared against a predefined number threshold for confirmation of the anomalous behaviour. The “predefined number threshold” refers to a pre-set maximum allowable count (or number) of the one or more anomalous events exceeding the predefined intensity threshold characterizing normal behaviour. Alternatively stated, the minimum number of the one or more anomalous events exceeding the predefined intensity threshold to thereby confirm the anomalous behaviour. Thus, the predefined intensity threshold and the predefined number threshold collectively (or individually) enable the method to confirm the anomalous behaviour for the self-exciting point process and thereby further enables accurate and precise modifications of the state of the device using the detected anomalous behaviour. Details of exemplary online anomaly detection process is illustrated in FIG. 7.

However, since the one or more anomalous events are typically short-term anomalies at respective time instants of the second time period and thus, may or may not indicate an underlying issue for the anomalous behaviour of the self-exciting point process. Thus, optionally, to accurately confirm the anomalous behaviour, long-term anomalies are also considered and analyzed by the method for final confirmation thereof. In an embodiment, the method further comprises determining, for the second time period, presence of at least one anomalous event (i.e., a confirmed anomalous event) of the one or more anomalous events with the corresponding determined intensity exceeding a predefined intensity threshold and determining, for a third time period, presence of at least one anomalous event with a corresponding determined intensity exceeding the predefined intensity threshold, with the third time period succeeding the second time period. Thus, the method is configured to determine presence of at least one anomalous event in each of the second time period and the third time period corresponding to the selected second portion and the third portion, respectively. Consequently, the method further comprises confirming the anomalous behaviour for the self-exciting point process based on the determined presence of at least one anomalous event with the corresponding determined intensity exceeding the predefined intensity threshold for each of the second time period and the third time period. Beneficially, such confirmations of the anomalous behaviour i.e., associated with both short-term and long-term anomalies increases the accuracy and efficiency of the anomaly detection process and thereby enables the method to modify the state of the device accurately and effectively.

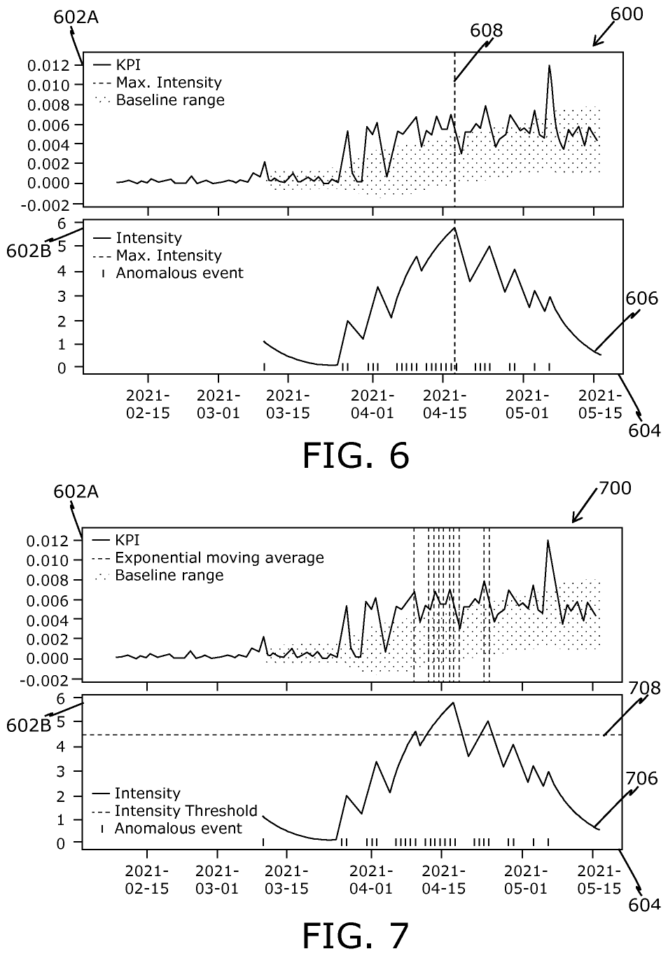

In an embodiment, the method further comprises sorting the one or more anomalous events based on the corresponding determined intensities in a descending order to indicate a degree of the anomalous behaviour for the self-exciting point process. Typically, in cases of offline anomaly detection for the self-exciting point process, the method further comprises sorting the one or more anomalous events in a descending order of the corresponding determined intensities and thus enables obtaining the maximum intensity associated with one of the one or more anomalous events. Herein, beneficially, offline detection comprises ranking anomalies based on the maximum value of the intensity function and does not require any further computations or processing to be performed. Details of exemplary offline anomaly detection process and the obtained maximum intensity is illustrated later in FIG. 6.

In one or more embodiments, the method further comprises generating an error alert upon confirmation of the anomalous behaviour for the self-exciting point process. Typically, upon confirmation of the anomalous behaviour for the self-exciting point process or the one or more anomalous events, the method further comprises generating an error alert indicating confirmation of the anomalous behaviour. The error alert may be any form of an audio alert, a textual alert, a vibrational alert and the like, configured to indicate the confirmation of the anomalous behaviour. Thus, each time the time series data exhibits anomalous behaviour i.e., each time the threshold (i.e., intensity and/or number threshold) is breached, the method generates the error alert, however, optionally, a subsequent alert may be ignored by the method if a given error alert has already been raised.

The method further comprises modifying the state of the device based on the characterized one or more anomalous events. The modification of the state of the device relates to an automated remediation action configured to change or modify the state of the device. Typically, based on the characterized one or more anomalous events, the method is configured to modify the state of the device, wherein based on the applied domain and the characterized one or more anomalous events, the modification is beneficially varied. In an exemplary scenario of the telecommunication domain, the device is a mobile radio access network (RAN) 4G base station (BS). Herein, a characterized first anomalous event indicates “inactive or suspended operation” and thereby associated first modification is an automated reset action for resetting or restarting the base station. Further, a characterized second anomalous event indicates “active or desired operation” and thereby associated second modification is an automated quarantine action for isolating the base station from further automated actions for a specified time period. Furthermore, a characterized third anomalous event indicates “an inefficient state” and thereby associated third modification is an automated adjustment of the power control settings for the base station. Furthermore, a characterized fourth anomalous event indicates “a dispositioned state” and thereby associated fourth modification is an automated tilting action of the base station sector (or antenna) by a desired angle. In another exemplary scenario, the device is any type of digital subscriber line (xDSL) modem. Herein, a characterized anomalous event indicates “inactive or suspended operation” and thereby associated modification is an automated reboot action for rebooting the xDSL modem. In yet another exemplary scenario, the device is a mobile 5G RAN. Herein, a characterized anomalous event indicates “active or desired operation” and thereby associated modification is an automated preventive action for isolating the mobile 5G RAN from further automated actions and automatically creating a service request (or ticked) for field service by domain experts at the location of the device. Beneficially, the method is configured to modify the state of the device based on the characterized anomalous events and thereby strategically remedying the issue faced via the automated actions (as described earlier) associated with the modification of the state of the device. Moreover, such a modification improves the efficiency of the system and significantly reduces the time taken in comparison to conventional systems and thus makes the entire process faster. As a further technical effect of using detection of one or more second point values in the second portion exceeding the defined baseline range, begin characterized as the one or more anomalous events for at least the second time period of the self-exciting point progress, is that modification of the state of the devices is done when it is really needed. Indeed this will, at least partly, remove problem of unnecessary modification of the state of the device, for example in case, where an anomalous event is of a very short duration (such as a server going down for a few seconds or if there is a temporary, short duration, communication break). This is will keep also entire system more stable and reduce unnecessary maintenance actions.

Optionally, the method may employ external systems or devices such as autonomous devices, for example sensors, actuators, transceivers, controllers, etc., that may be employed to monitor physical, operational, or environmental conditions at different device locations, such as, e.g., efficiency, energy, power consumption, resource consumption, temperature, pressure, vibration, sound, radiation, motion, pollutant level and the like to enable the method to detect anomalous behaviour and thereby modify the state of the associated device such as via actuators, controllers, transceivers and the like.

In another aspect, the present disclosure also provides computer program comprising computer executable program code which, when executed by a processor, causes a system to carry out the steps of the method for modifying the state of the device using detected anomalous behaviour in the self-exciting point process.

In another aspect, the present disclosure also provides a system for modifying a state of a device using detected anomalous behaviour in a self-exciting point process. The various embodiments and variants disclosed above apply mutatis mutandis to the present system without any limitations. The system comprises a processor, and a memory including computer program code, wherein the memory and the computer program code are configured to, with the processor, cause the apparatus to perform the method for modifying a state of a device using detected anomalous behaviour in a self-exciting point process as described in the present disclosure.

The “processor” refers to a computational element that is operable to respond to and processes instructions that drive the system for modifying a state of a device using detected anomalous behaviour in a self-exciting point process. In an embodiment, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the system.

The “memory” as used herein refers to a computer readable storage medium for providing a non-transient memory may include, but is not limited to, an electronic storage device, a magnetic storage device, an optical storage device, an electromagnetic storage device, a semiconductor storage device, or any suitable combination of the foregoing, in which a computer can store data or software for any duration. In an embodiment, the memory is a. Furthermore, a single memory may encompass and, in a scenario, in case the system is distributed, the processing, memory and/or storage capability may be distributed as well. In an embodiment, the memory is a non-volatile mass storage such as physical storage media or a non-transitory computer-readable storage medium including, but not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

In yet another aspect, the present disclosure provides a system for modifying a state of a network device, implemented in a networked environment, using detected anomalous behaviour in a self-exciting point process, the system comprising a processor and a memory comprising computer program code, configured to:
receive time series data, associated with the network device, for a time period comprising point values for respective time instants of the time period for the self-exciting point process;
select a first portion, corresponding to a first time period, from the received time-series data, characterizing a normal behaviour for at least the first time period of the self-exciting point process;
define a baseline range for the self-exciting point process based, at least in part, on bounds of first point values in the selected first portion;
process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process; and
modify a state of the network device based on the characterized one or more anomalous events, wherein the modified state is at least one of an active state or an inactive state.

The system is configured for modifying the state of the network device, implemented in the networked environment, using detected anomalous behaviour in the self-exciting point process. Herein, the “state of the network device” refers to an operating state of the network device implemented in the networked environment that is modified via automated actions based on detected anomalous behaviour. In an example, the network device comprises at least one of a hub, a repeater, a bridge, a switch, a gateway, an access point, a base station, an antenna, a transceiver, a wireless device, a cellular phone, a modem and the like. Typically, the networked environment comprises multiple network devices being monitored and modified by the system and is operable to provide a medium for the network devices to interact with each other or the system.

The “networked environment” refers to an arrangement of interconnected programmable and/or non-programmable components that are configured to facilitate data communication between the system and the network device(s), whether available or known at the time of filing or as later developed. Furthermore, the networked environment may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the networked environment comprises wired or wireless communication that can be carried out via any number of known protocols, including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed. Moreover, although the system is frequently described herein as being implemented with TCP/IP communications protocols, the system may also be implemented using IPX, AppleTalk®, IP-6, NetBIOS, OSI, any tunnelling protocol (e.g., IPsec, SSH), or any number of existing or future protocols.

The system comprises the processor and the memory comprising computer program code, configured to receive time series data, associated with the network device, for a time period comprising point values for respective time instants of the time period for the self-exciting point process. The time series data is associated with the time period further comprising multiple time periods that may be separately analyzed by the system for detecting anomalous behaviour therein. The processor is further configured to select a first portion, corresponding to a first time period, from the received time-series data, characterizing a normal behaviour for at least the first time period of the self-exciting point process. The processor is further configured to define a baseline range for the self-exciting point process based, at least in part, on bounds of first point values in the selected first portion. Typically, based on the selected first portion a normal behavioral range i.e., the baseline range is defined to detect anomalous behaviour in subsequent time periods or times series data. The processor is further configured to process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process. Typically, the processing of the second portion based on the defined baseline range enables the system to detect the one or more second point values exceeding the defined baseline range and are thereby characterized as the one or more anomalous events of the self-exciting process. The processor is further configured to modify the state of the network device based on the characterized one or more anomalous events, wherein the modified state is at least one of an active state or an inactive state. In an exemplary scenario of the networking domain, the network device is a mobile radio access network (RAN) 4G base station (BS). Herein, a characterized anomalous event of the one or more anomalous events indicates the inactive state and thereby associated first modification is an automated reset action for resetting or restarting the base station and thereby modifying the state of the network device to the active state from the inactive state. In another exemplary scenario, the device is a mobile 5G RAN. Herein, a characterized anomalous event indicates the active state and thereby associated modification is an automated preventive action for isolating the mobile 5G RAN from further automated actions and automatically creating a service request (or ticked) for field service by domain experts at the location of the device.

In an embodiment, the processor is further configured to determine an intensity of a given anomalous event of the one or more anomalous events based on at least one of a number and a proximity in time of preceding anomalous events of the one or more anomalous events to the given anomalous event. In another embodiment, the processor is further configured to compare the determined intensity of each of the one or more anomalous events with a predefined intensity threshold and count a number of the one or more anomalous events with the corresponding determined intensity exceeding the predefined intensity threshold to confirm the anomalous behaviour for the self-exciting point process based on the counted number exceeding a predefined number threshold. Thus, upon confirming the anomalous behaviour of the one or more anomalous events based on comparison with the predefined intensity threshold and the predefined number threshold, the processor is further configured to modify the state of the network device based on the confirmation of the anomalous behaviour.

However, since the one or more anomalous events are typically short-term anomalies at respective time instants of the second time period and thus, may or may not indicate an underlying issue for the anomalous behaviour of the self-exciting point process. Thus, optionally, to accurately confirm the anomalous behaviour, long-term anomalies are also considered and analyzed by the system for final confirmation thereof. In another embodiment, the processor is further configured to determine, for the second time period, presence of at least one anomalous event of the one or more anomalous events with the corresponding determined intensity exceeding a predefined intensity threshold and determine, for a third time period, presence of at least one anomalous event with a corresponding determined intensity exceeding the predefined intensity threshold, with the third time period succeeding the second time period to confirm the anomalous behaviour for the self-exciting point process based on the determined presence of at least one anomalous event with the corresponding determined intensity exceeding the predefined intensity threshold for each of the second time period and the third time period. Thus, upon confirming the presence of at least one anomalous event in each of the second and third time period, the processor is further configured modify the state of the network device based on the confirmation of the anomalous behaviour. Beneficially, such a modification of the network device by the system is highly accurate and precise and thereby enables the system to detect and thereby correct the detected anomalies in a fast and efficient manner.

According to one aspect a method for modifying a state of a device using detected anomalous behaviour in a self-exciting point process, comprising:
receiving time series data for a time period comprising point values for respective time instants of the time period for the self-exciting point process, wherein the time series data is a series of the point values with respect to time, wherein the point values are data points in the time series data, and wherein the self-exciting point process is obtained as the series of the point values that indicates one or more anomalous events where the point values of the time series data fall outside a baseline range;
selecting a first portion, corresponding to a first time period, from the received time-series data, characterizing a normal behaviour for at least the first time period of the self-exciting point process;
defining a baseline range for the self-exciting point process based, at least in part, on bounds of first point values in the selected first portion;
processing a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process;
determining an intensity of a given anomalous event of the one or more anomalous events based on at least one of a number and a proximity in time of preceding anomalous events of the one or more anomalous events to the given anomalous event;
determining, for the second time period, presence of at least one anomalous event of the one or more anomalous events with the corresponding determined intensity exceeding a predefined intensity threshold;
determining, for a third time period, presence of at least one anomalous event with a corresponding determined intensity exceeding the predefined intensity threshold, with the third time period succeeding the second time period;
confirming the anomalous behaviour for the self-exciting point process based on the determined presence of at least one anomalous event with the corresponding determined intensity exceeding the predefined intensity threshold for each of the second time period and the third time period; and
modifying the state of the device based on the confirmation of the anomalous behaviour for the self-exciting point process wherein the modified state is at least one of an active state or an inactive state.

The detected anomalous behaviour relates to anomalies present in any self-exciting point process, for example associated with an operation of a component or the device, wherein any issues or errors during operation of said component or device is deemed an anomaly. The disclosed system is enabled to confirm the anomalous behaviour for the self-exciting point process and thereby further enable accurate and effective modifications of the state of the device using the detected anomalous behaviour. The effect of this is to provide confirmations of the anomalous behavior associated with both short-term and long-term anomalies that increases the accuracy and efficiency of the anomaly detection process and thereby enables the method to modify the state of the device accurately and effectively.

Indeed, the method is configured to determine presence of at least one anomalous event in each of the second time period and the third time period corresponding to the selected second portion and the third portion, respectively. Consequently, the method further comprises confirming the anomalous behaviour for the self-exciting point process based on the determined presence of at least one anomalous event with the corresponding determined intensity exceeding the predefined intensity threshold for each of the second time period and the third time period. Furthermore, the present disclosure discloses that the modification of the state of the device relates to an automated remediation action configured to change or modify the state of the device. Such a modification improves the efficiency of the system and significantly reduces the time taken in comparison to conventional systems and thus makes the entire process faster.

### DETAILED DESCRIPTION OF THE DRAWINGS

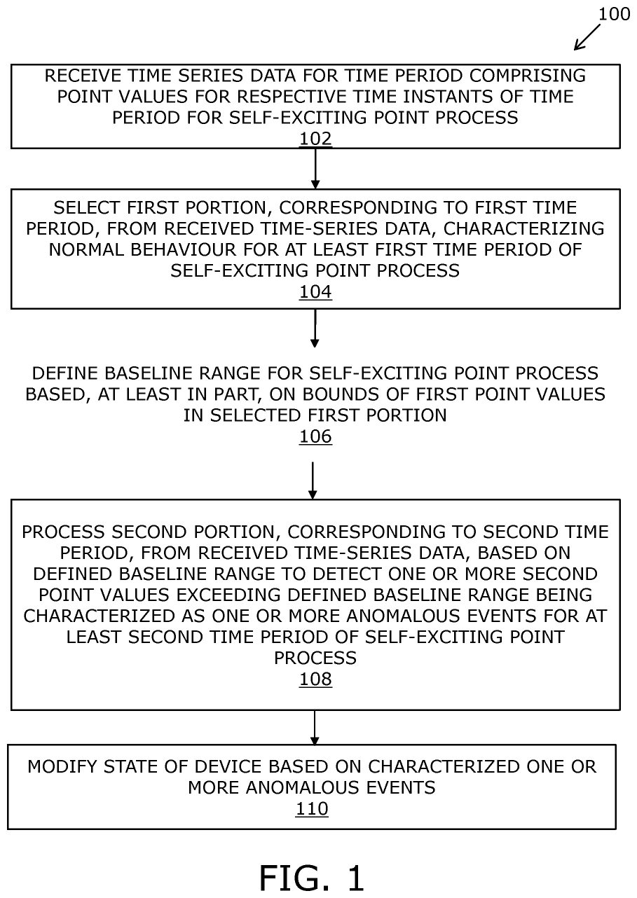

Referring to FIG. 1, illustrated is a flowchart listing steps involved in a method for modifying a state of a device using detected anomalous behaviour in a self-exciting point process, in accordance with an embodiment of the present disclosure. With reference to FIG. 1, there is shown a flowchart 100. The steps of the flowchart 100 may start at step 102.

At a step 102, the method 100 comprises receiving time series data for a time period comprising point values for respective time instants of the time period for the self-exciting point process.

At a step 104, the method 100 comprises selecting a first portion, corresponding to a first time period, from the received time-series data, characterizing a normal behaviour for at least the first time period of the self-exciting point process.

At a step 106, the method 100 comprises defining a baseline range for the self-exciting point process based, at least in part, on bounds of first point values in the selected first portion.

At a step 108, the method 100 comprises processing a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process.

And, at a step 110, the method 100 comprises modifying the state of the device based on the characterized one or more anomalous events.

It may be appreciated that the steps 102 to 110 are only illustrative, and other alternatives can also be provided where one or more steps are added, one or more steps are removed, or one or more steps are provided in a different sequence without departing from the scope of the present disclosure.

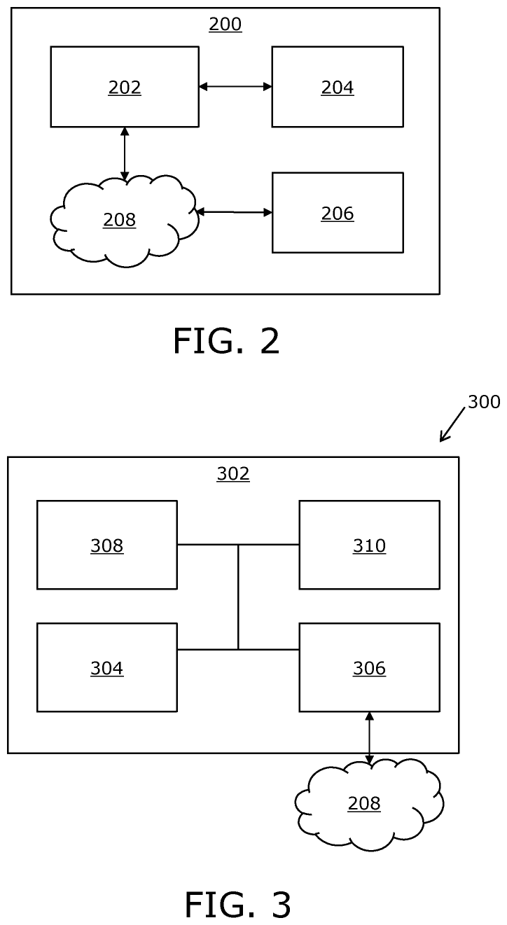

Referring to FIG. 2, illustrated is a schematic illustration of a block diagram of a system 200 for modifying a state of a device using detected anomalous behaviour in a self-exciting point process, in accordance with an embodiment of the present disclosure. With reference to FIG. 2, there is shown a block diagram of the system 200, wherein the system 200 includes a processor 202, a memory 204, a device 206. The system 200 comprises the processor 202, and the memory 204 including computer program code, wherein the memory 204 and the computer program code configured to, with the processor 202, cause the apparatus to perform the method 100.

Referring to FIG. 3, illustrated is an exemplary schematic illustration of a network environment 300 comprising a system 302 for modifying a state of a network device 304 using detected anomalous behaviour in a self-exciting point process, in accordance with an embodiment of the present disclosure. With reference to FIG. 3, there is shown a networked environment 300. The networked environment 300 comprises a network interface 306 configured to connect and provide means for data communication to and from the system 302 and the network device(s) 304 to further enable the system 300 to modify the state of the network device 304 using detected anomalous behaviour. As shown, the system 302 comprises a processor 308 and a memory 310 comprising computer program code, configured to receive time series data, associated with the network device 304, for a time period comprising point values for respective time instants of the time period for the self-exciting point process. The processor 308 is further configured to select a first portion, corresponding to a first time period, from the received time-series data, characterizing a normal behaviour for at least the first time period of the self-exciting point process and define a baseline range for the self-exciting point process based, at least in part, on bounds of first point values in the selected first portion. The processor 308 is further configured to process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process. The processor 308 is further configured to modify the state of the network device 304 based on the characterized one or more anomalous events, wherein the modified state is at least one of an active state or an inactive state.

Referring to FIGS. 4A and 4B, illustrated are graphical illustrations 400A and 400B of a first time series data and second time series data depicting normal behaviour, in accordance with various embodiments of the present disclosure. Herein, the graphical illustrations 400A and 400B are representations of the key performance indicators of the first time series data and the second time series data, respectively. As shown, each of the graphical illustrations 400A and 400B comprises a y-axis 402 representing a determined intensity value and an x-axis 404 representing a time period of the respective time series data. It will be appreciated that FIGS. 4A and 4B may be read in conjunction with FIGS. 1 and 2 and specifically in conjunction with FIG. 3. In operation, the system 302 comprising the processor 308 and the memory 310, is configured to receive the first time series data and the second time series data having an associated time period of three months dated from 15 Feb. 2021 to 15 May 2021. Further, as shown, the processor 308 is configured to select first portions 406A and 406B, corresponding to first time periods from amongst the time periods of the received first and second time-series data, respectively. For example, the first time periods may be for a one-month period. Furthermore, the processor 308 is configured to characterize a normal behaviour for at least the first time periods of the self-exciting point process and define baseline ranges 410A and 410B for the self-exciting point process based, at least in part, on bounds of first point values in the selected first portions 406A and 406B, wherein the baseline ranges 410A and 410B are defined based on an exponential moving average estimation. Furthermore, the processor 308 is configured to process second portions 408A and 408B, corresponding to second time periods from amongst the time periods of the received first and second time-series data, respectively, based on the defined baseline ranges 410A and 410B. For example, the baseline range 410A or 410B is defined for a 1-month period (corresponding to the selected first portion 406A or 406B) out of the total time period of three months, wherein the selected second portion 408A or 408B is processed against the baseline range 410A or 410B, respectively.

Referring to FIGS. 5A and 5B, illustrated are graphical illustrations 500A and 500B of a first time series data and second time series data respectively depicting anomalous behaviour in self-exciting point processes 506A and 506B, in accordance with various embodiments of the present disclosure. Herein, the graphical illustrations 500A and 500B are representations of the key performance indicators of the first time series data and the second time series data, respectively. As shown, each of the graphical illustrations 500A and 500B comprise a y-axis 502 representing a determined intensity value and an x-axis 504 representing a time period of the respective time series data. It will be appreciated that FIGS. 5A and 5B may be read in conjunction with FIGS. 1, 2, 3, 4A and 4B. In operation, the system 302 comprising the processor 308 and the memory 310, is configured to receive the first time series data and the second time series data having an associated time period of three months dated from 15 Feb. 2021 to 15 May 2021. Further, as shown, the processor 308 is configured to select first portions 508A and 508B, corresponding to first time periods from amongst the time periods of the received first and second time-series data, respectively. For example, the first time periods may be for a one-month period. Furthermore, as shown, the processor 308 is configured to characterize a normal behaviour for the received first and second time series data and define baseline ranges 510A and 510B for the self-exciting point process, wherein the baseline ranges 510A and 510B are defined based on an exponential moving average estimation. Furthermore, the processor 308 is configured to process second portions 512A and 512B, corresponding to second time periods from amongst the time periods of the received first and second time-series data, respectively, based on the defined baseline ranges 510A and 510B to detect one or more second point values in the second portions 512A and 512B exceeding the defined baseline ranges 510A and 510B, with the detected one or more second point values in the second portions 512A and 512B exceeding the defined baseline ranges 510A and 510B being characterized as the one or more anomalous events 514 (depicting anomalous behaviour) for at least the second time periods of the self-exciting point processes 506A and 506B. For example, the baseline range 510A or 510B is defined for a 1-month period (corresponding to the selected first portion 508A or 508B) out of the total time period of three months, wherein the selected second portion 512A or 512B (corresponding to a 2-month time period) is processed against the baseline range 510A or 510B, respectively, to detect the one or more second point values characterizing the one or more anomalous events 514.

Referring to FIG. 6, illustrated is a graphical illustration 600 of a time series data depicting anomalous behaviour in a self-exciting point process, in accordance with an embodiment of the present disclosure. Herein, the graphical illustration 600 is a representations of key performance indicators and determined intensity values associated with the time series data for offline anomaly detection. As shown, the graphical illustration 600 comprises a first y-axis 602A representing key performance indicators, a second y-axis 602B representing determined intensity values (or intensity curve) and an x-axis 604 representing a time period of the time series data. It will be appreciated that FIG. 6 may be read in conjunction with FIGS. 1, 2, 3, 4A, 4B, 5A and 5B. In operation, the processor 308 is configured to determine an intensity of a given anomalous event of the one or more anomalous events 514 based on at least one of a number and a proximity in time of preceding anomalous events of the one or more anomalous events 514 to the given anomalous event. Further, upon determining the intensity of the given anomalous event of the one or more anomalous events 514, the processor 308 is configured to sort the one or more anomalous events 514 in a descending order based on the determined intensity 606 to indicate a degree of the anomalous behaviour for the self-exciting point process and thereby determine the maximum intensity 608 for the one or more anomalous events 514 to enable offline anomaly detection.

Referring to FIG. 7, illustrated is a graphical illustration 700 of a time series data depicting anomalous behaviour in a self-exciting point process, in accordance with another embodiment of the present disclosure. Herein, the graphical illustration 700 is a representations of key performance indicators and determined intensity values associated with the time series data for online anomaly detection. As shown, the graphical illustration 700 comprises a first y-axis 702A representing the key performance indicators and a second y-axis 702B representing a determined intensity values (or intensity curve) and an x-axis 704 representing a time period of the time series data. It will be appreciated that FIG. 7 may be read in conjunction with FIGS. 1, 2, 3, 4A, 4B, 5A and 6. In operation, the processor 308 is configured to determine an intensity 706 of a given anomalous event of the one or more anomalous events 514 based on at least one of a number and a proximity in time of preceding anomalous events of the one or more anomalous events 514 to the given anomalous event. Further, upon determining the intensity 706 of the given anomalous event of the one or more anomalous events 514, the processor 308 is configured to compare the determined intensity 706 of each of the one or more anomalous events 514 with a predefined intensity threshold 708, counting a number of the one or more anomalous events with the corresponding determined intensity exceeding the predefined intensity threshold and confirming the anomalous behaviour for the self-exciting point process based on the counted number exceeding a predefined number threshold.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for modifying a state of a device (206) using detected anomalous behaviour in a self-exciting point process, comprising:
receiving time series data for a time period comprising point values for respective time instants of the time period for the self-exciting point process, wherein the time series data is a series of the point values with respect to time, wherein the point values are data points in the time series data, and wherein the self-exciting point process is obtained as the series of the point values that indicates one or more anomalous events where the point values of the time series data fall outside a baseline range;
selecting a first portion, corresponding to a first time period, from the received time-series data, characterizing a normal behaviour for at least the first time period of the self-exciting point process;
defining a baseline range for the self-exciting point process based, at least in part, on bounds of first point values in the selected first portion;
processing a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process; characterized in that:
determining an intensity of a given anomalous event of the one or more anomalous events based on at least one of a number and a proximity in time of preceding anomalous events of the one or more anomalous events to the given anomalous event;
determining, for the second time period, presence of at least one anomalous event of the one or more anomalous events with the corresponding determined intensity exceeding a predefined intensity threshold;
determining, for a third time period, presence of at least one anomalous event with a corresponding determined intensity exceeding the predefined intensity threshold, with the third time period succeeding the second time period;
confirming the anomalous behaviour for the self-exciting point process based on the determined presence of at least one anomalous event with the corresponding determined intensity exceeding the predefined intensity threshold for each of the second time period and the third time period; and
modifying the state of the device based on the confirmation of the anomalous behaviour for the self-exciting point process wherein the modified state is at least one of an active state or an inactive state.

2. The method of claim 1 further comprising:
comparing the determined intensity of each of the one or more anomalous events with a predefined intensity threshold;
counting a number of the one or more anomalous events with the corresponding determined intensity exceeding the predefined intensity threshold; and
confirming the anomalous behaviour for the self-exciting point process based on the counted number exceeding a predefined number threshold.

3. The method of claim 1 further comprising sorting the one or more anomalous events based on the corresponding determined intensities in a descending order to indicate a degree of the anomalous behaviour for the self-exciting point process.

4. The method of claim 1 further comprising generating an error alert upon confirmation of the anomalous behaviour for the self-exciting point process.

5. The method of claim 1, wherein defining the baseline range comprises computing an exponential moving average estimation for the selected first portion of the received time series data.

6. The method of claim 5, wherein the exponential moving average estimation is based on the bounds of first point values and a weighting factor.

7. A method according to claim 1 wherein the device is at least one of: a network device, a communication device, a telecommunication device, a computing device; and the time series data is a measured key performance indicator (KPI) value relating to the device.

8. A computer program product comprising computer executable program code stored on non-transitory computer readable medium, which when executed by a processor causes a system to perform the method of claim 1.

9. A system comprising a processor, and a memory including computer program code; the memory and the computer program code configured to, with the processor, cause the apparatus to perform the method of claim 1.

10. A system for modifying a state of a network device, implemented in a networked environment, using detected anomalous behaviour in a self-exciting point process, the system comprising a processor and a memory comprising computer program code, configured to:
receive time series data, associated with the network device, for a time period comprising point values for respective time instants of the time period for the self-exciting point process, wherein the time series data is a series of the point values with respect to time, wherein the point values are data points in the time series data, and wherein the self-exciting point process is obtained as the series of the point values that indicates one or more anomalous events where the point values of the time series data fall outside a baseline range;
select a first portion, corresponding to a first time period, from the received time-series data, characterizing a normal behaviour for at least the first time period of the self-exciting point process;
define a baseline range for the self-exciting point process based, at least in part, on bounds of first point values in the selected first portion;
process a second portion, corresponding to a second time period, from the received time-series data, based on the defined baseline range to detect one or more second point values in the second portion exceeding the defined baseline range, with the detected one or more second point values in the second portion exceeding the defined baseline range being characterized as the one or more anomalous events for at least the second time period of the self-exciting point process; characterized in that:
determine an intensity of a given anomalous event of the one or more anomalous events based on at least one of a number and a proximity in time of preceding anomalous events of the one or more anomalous events to the given anomalous event;
determine, for the second time period, presence of at least one anomalous event of the one or more anomalous events with the corresponding determined intensity exceeding a predefined intensity threshold;
determine, for a third time period, presence of at least one anomalous event with a corresponding determined intensity exceeding the predefined intensity threshold, with the third time period succeeding the second time period;
confirm the anomalous behaviour for the self-exciting point process based on the determined presence of at least one anomalous event with the corresponding determined intensity exceeding the predefined intensity threshold for each of the second time period and the third time period; and
modify the state of the network device based on the confirmation of the anomalous behaviour, wherein the modified state is at least one of an active state or an inactive state.

11. The system of claim 10, wherein the processor is further configured to:
compare the determined intensity of each of the one or more anomalous events with a predefined intensity threshold;
count a number of the one or more anomalous events with the corresponding determined intensity exceeding the predefined intensity threshold;
confirm the anomalous behaviour for the self-exciting point process based on the counted number exceeding a predefined number threshold; and
modify the state of the network device based on the confirmation of the anomalous behaviour.
